(19) United States
(12) Patent Application Publication
(10) Pub. No.: US 2017/0128854 A1
(43) Pub. Date: May 11, 2017

(54) DISCONTINUOUS CRYSTALLIZATION UNIT FOR THE PRODUCTION OF BALL-SHAPED CRYSTALS

(71) Applicant: ERUCA TECHNOLOGIES S.R.O., Novy Bohumin (CZ)

(72) Inventors: Martin Soucek, Opava (CZ); Jan Mysik, Ostrava-Poruba (CZ); Jan Kupka, Ostrava-Proskovice (CZ)

(21) Appl. No.: 15/127,721

(22) PCT Filed: Jan. 22, 2015
(86) PCT No.: PCT/CZ2015/000007

§ 371 Date: Sep. 20, 2016

(30) Foreign Application Priority Data
Mar. 28, 2014 (CZ) PV 2014-207

(51) Int. Cl. B01D 9/00; C06B 29/22; C06B 21/00

(52) U.S. Cl. CPC B01D 9/0013; B01D 9/0063; C06B 21/0066; C06B 29/22; B01D 2009/0086

(57) ABSTRACT

The invention introduces a discontinuous crystallization unit for the production of ball-shaped crystals comprising a crystallizer (1) that consists of a metallic cylindrical vessel with its inner surface of a hard material, with an oval or circular cross-section with a conical or vaulted bottom (12), fitted along its length with a duplicator (4) for cooling of the solution and/or suspension of the solution and crystals and a high-speed agitator (8) of a hard material with a drive (9) enabling speed control and thus the rate of the impact of the mechanical action of the agitator on roundness of crystals inside the vessel together with the inner surface of the vessel containing at least 2 baffles (5) of a hard material while the vessel is fitted with at least 1 orifice (10) at the top that at least independent branch of the circulation circuit (11) is connected to from the outside for the inlet of a heated solution and/or heated suspension of the solution and crystals by means of at least 1 circulation pump (2) and through at least 1 heat exchanger (3) and together with the duplicator (4) ensuring controlled periodic changes of temperatures of the crystal suspension around the cooling curve while an interconnection (13) pipeline is connected to the bottom (12) of the crystallizer (1) vessel that is connected to at least one branch of the circulation circuit (11).

### FIELD OF THE INVENTION

The invention deals with a discontinuous crystallization unit for the production of small to medium-sized ball-shaped crystals, preferably crystals of ammonium perchlorate (APC).

### BACKGROUND ART

In the prior art several methods for the production of ball-shaped crystals have been described. It is known, both from the theory and practice, that small crystals exhibit higher solubility than larger crystals and that a rectangular crystal surface dissolves more easily that a ball-shaped surface. Crystallization that is conducted in such a way that the temperature periodically fluctuates around the saturated solution temperature is based on this phenomenon. Thus, crystal nuclei, small crystals and rectangular crystal surfaces dissolve more easily and on the other hand, large crystals manifest preferential growth. This way, a rough-grained product is produced.

An example of this method for the production of ball-shaped crystals is e.g. the CS patent 105232 (Nývlt, J., published on Apr. 15, 1962), which describes a crystallization process to obtain a rough-grained product without admixed small crystals. This method is based on the crystal suspension in the mother liquor being exposed to a periodical change of one of the quantities (temperature, pressure, solvent volume) around the equilibrium curve of the saturated solution.

The CS patent 112280 (Nývlt, J., Horá\check{c}ek S., published Apr. 15, 1964) deals with a crystallization process for the production of round crystals. The patented crystallization method is based on the general principle that temperature fluctuation around the saturated solution temperature causes rounding of crystals. This is achieved by circulation of suspension of crystals in a solution between two parts of a device, one of which is above the saturation temperature and the other one below the saturation temperature.

On the basis of the above mentioned process a crystallizer was patented in the Czechoslovak patent 112306 (Nývlt, J., et al., published on Apr. 15, 1964). It is designed as one device of a generally circular cross-section with a conical bottom part. The crystallizer is divided into two spaces with a partition between which suspension of the crystallized compound circulates. The circulation is ensured by the activity of agitators and static tube plates with an annular shape that are part of both the spaces. The tube plates fulfill the function of heat exchangers at the same time. An optional part is a double exchanger. A suitable connection of the heat exchangers is used to achieve such a situation that the temperatures in both the crystallizer spaces are different so that the temperature of the circulating mixture periodically fluctuates.

The U.S. Pat. No. 3,599,701 (Mollerstedt et al., granted on Aug. 17, 1971) deals with a production process of round crystals with a narrow distribution of the particle size. The process consists of two main processes. The first one is dissolution and the other one is crystallization while the suspension (crystals and mother liquor) circulates between them. The dissolution is achieved by inlet of such a quantity of water to the suspension to dissolve a part of the crystals only (primarily the smallest and most rectangular ones). Crystallization is done by air bubbling, which removes a part of water from the suspension. The bubbling together with vigorous agitation of the whole suspension maintains even growth of ball-shaped crystals which is also supported by mutual mechanical interaction of the crystals. A part of the suspension from the crystallizer is removed for separation of the product (crystals). The production is continuous.

Another production method of ball-shaped crystals is based on “beating” of crystals that are formed during the crystallization process with a high-speed agitator. This method produces very small particles, which is associated with a number of problems during further processing of the product (poor filtration capability, product sintering, dust formation). During the crystallization process by beating with a high speed agitator crystal edges are preferably beaten off. However, when this method is used, very small particles (fragments) are additionally formed, which are undesirable.

Ball-shaped crystals of ammonium perchlorate are described in the U.S. Pat. No. 3,383,180 (Kralik et al., granted on May 14, 1968) while it deals with a production process of large crystals of ammonium perchlorate—APC (200 to 1000 micrometres) with a low content of inclusions suitable for propellant production. In a dissolution vessel hot (approx. 80° C.), nearly saturated solution of APC is prepared. It is prepared by dissolution of crude APC in waste mother liquor and APC suspension in the mother liquor that is supplied from the crystallizer. The resulting solution is fed into the crystallizer (circulation circuit between the crystallizer and the dissolution vessel). The crystallizer contains hot suspension of APC crystals in the mother liquor. By the action of reduced pressure water evaporates and crystals grow. The design of the crystallizer with inserted intermediate partitions and a low-speed agitator installed in a tube ensures axial streaming of the suspension. The bottom part of the crystallizer with the shape of a narrow pipe (“leg”), which the second circulation circuit is connected to at the bottom, has the function of a crystal separator (large crystals fall down, smaller ones are carried upwards). The third circulation circuit of the crystallizer leads through a device with the function of a mill (e.g. a colloidal mill or gear pump) where crystals are ground to a smaller size (up to hundredfold radius reduction); this way particles are produced that will act as new nuclei as well as particles that participate in controlling the saturation of the mother liquor through their dissolution. From the bottom part of the crystallizer the product is removed to the separator where APC crystals axe separated from the mother liquor, which returns to the beginning of the process. This process is continuous.

Another US patent of the same author U.S. Pat. No. 3,498,759 (Kralik et al., granted on Mar. 3, 1970) deals with a production process of round crystals of ammonium perchlorate—APC (approx. 200 micrometers). The process has two main parts between which suspension of APC crystals in the mother liquor circulates. The first one of them is the “dissolution zone”. It is an agitated vessel where heat inlet and an “unsaturated” solution (charge) cause crystal dissolution. The other one is the crystallizer where water evaporates and crystals subsequently grow due to a reduced pressure. The crystallizer consists of a funnel-shaped top part (here, suspension is supplied from the dissolution zone and evaporation occurs) and the bottom part (this is where crystals grow and suspension is routed back to the dissolution zone). From the bottom part of the crystallizer the product is removed to the separator where APC crystals are separated from the mother liquor, which returns to the beginning of the process. This process is continuous.

The U.S. Pat. No. 3,222,231 (Markels et al., granted on Dec. 7, 1965) uses a process of high-frequency acoustic vibrations for the production of round APC crystals. The crystallization occurs due to slow cooling of an agitated hot saturated solution of ammonium perchlorate—APC. Simultaneously acting high-frequency acoustic vibrations make sure that the formed APC crystals have a ball-shaped character. Depending on the conditions (especially the crystallization rate) crystals with the size from approx. 5 to approx. 350 micrometers can be obtained.

The above mentioned prior art methods make it obvious that there is a need to produce crystals that would have a small to medium size, having at the same time a ball-like to round shape, using a technology based on a special crystallization device that would make use of the advantages of the above mentioned methods.

It would be preferable to use this device for the production of medium-sized ball-shaped to round crystals of ammonium perchlorate—APC obtained especially from recycling of solid rocket propellant.

Therefore, for this purpose, recycling of APC from propellant should be based on a completely new design and structure of the crystallization unit.

### SUMMARY OF THE INVENTION

The above mentioned requirements resulting from the prior art are met by providing a crystallization unit in accordance with this invention, which is partly based on the above mentioned findings to produce small to medium-sized ball-shaped crystals as these sizes are the most demanded ones in the market.

The crystallization device consists of a specially designed metallic crystallizer fitted with a high-speed agitator that ensures mechanical treatment—mechanical impacting, i.e. “beating” of crystals. Circulation pumps are then used to direct the resulting small particles through a pipe heat exchanger that ensures dissolution of nuclei, small crystals, produced fragments and/or crystal edges and then returned to the crystallizer space, which gives them their round shape.

The object of the invention is a discontinuous crystallization unit that comprises a crystallizer that consists of a metallic cylindrical vessel with its inner surface of a hard material, with an oval or circular cross-section with a conical or vaulted bottom, fitted along most of its length with a duplicator for cooling of the solution and/or suspension of the solution and crystals and a high-speed agitator of a hard material with a drive enabling speed control and thus the rate of the impact of the mechanical action of the agitator on roundness of crystals inside the vessel together with the inner surface of the vessel containing at least 2 baffles of a hard material while the vessel is fitted with at least 1 orifice at the top that at least 1 independent circulation circuit is connected to from the outside for the inlet of a heated solution and/or heated suspension of the solution and crystals by means of at least 1 circulation pump and through at least 1 heat exchanger and together with the duplicator ensuring controlled periodic changes of temperatures of the crystal suspension around the cooling curve while an interconnection circuit is connected to the bottom of the crystallizer vessel that is connected to at least one branch of circulation circuit.

For the discharge of crystal suspension from the crystallizer for further processing the interconnection circuit contains, preferably before the connection line to the circulation circuit branch, a branching element, which may be e.g. a T-piece, with a subsequent branch containing stop valves, which may be a valve, cock, flap valve or slide valve, preferably automatic.

With the use of the above mentioned crystallization unit round crystals have been prepared as e.g. crystals of ammonium perchlorate, which forms crystals with sharp edges under common crystallization conditions.

In accordance with the invention the entire crystallization unit works in a discontinuous regime.

With the use of this device in accordance with the invention and a suitable parameter setting ball-shaped products of a small to medium crystal size from approx. 100 to approx. 300 micrometers, preferably approx. 200 micrometers are obtained, which are the most demanded ones in the market. Crystals produced in this device also exhibit a preferable very narrow particle size distribution.

These crystals are preferably ball-shaped crystals of ammonium perchlorate (APC).

The crystallization device consists of a specially designed discontinuous crystallization unit that comprises a metallic crystallizer fitted with a high-speed agitator with the speed control possibility, which ensures “beating” of the crystals and thus the rate of the mechanical impact of the agitator on roundness of crystals inside the vessel in the mixture of the saturated solution and crystals while the beating is implemented by hitting against the agitator blades as well as hitting against the crystallizer walls of a hard material, but also by the crystals hitting each other.

To improve the efficiency of the rate of mechanical impact on the crystals, i.e. crystal “beating” the crystallizer contains at least 2 baffles inside made of a material with the same hardness as the high-speed agitator and the inner surface of the crystallizer walls.

If the number of these baffles is higher, it is just another design version falling within the scope of this invention.

As the hard material stainless steel, enameled metal or glass can be preferably used while in accordance with the invention it is also necessary for the Brinell hardness of these materials to achieve at least 120 HB, preferably at least 200 HB.

The crystallizer is cooled from the outside nearly all along the length of its surface as a duplicator vessel.

The crystal mixture is circulated, with the use of at least one circulation pump (ensuring crystal beating as well), through at least one heat exchanger, preferably a tubular heat exchanger, which supplies heat on the other hand.

As the circulation pump a centrifugal pump with an open impeller of a hard material as mentioned above can be preferably used.

So the mixture of crystals in the suspension is periodically exposed to temperature oscillation (to ensure preferential growth of bigger and round crystals). The value around which the temperature oscillates decreases during crystallization (thus, crystallization is guided/caused by a temperature reduction of solubility).

The crystallization unit in accordance with the invention is able to provide significant inventive elements of the production technology of round crystals, as:

preventing the occurrence of undesired fine particles;
excellent control of the crystallization parameters and thus easy setting of the mean size and distribution range of the particle size;
excellent reproducibility of crystallization;
efficient implementation of the mechanical treatment principle-crystal “beating”, which is implemented in several ways at the same time (agitator, pump, crystallizer walls and baffles).

In particular, the “beating” intensity can be effected by the hardness of selected materials, number of agitator blades, impeller type of the circulation pump and the number of circulation circuits. The “beating” intensity can be controlled by changes of the agitator speed and/or rotation speed of the pump impeller(s).

The crystallization unit in accordance with the invention is actually provably able to produce round crystals while combining two rounding principles (mechanical treatment-beating and dissolution), allowing preparation of medium-sized, high-quality crystals.

As the crystallization unit in accordance with the invention features the possibility to control the cooling rate and heating rate (temperature difference at the exchanger inlet and outlet), the process is easily and precisely controllable.

Thanks to this crystallization unit all the crystals regardless of their size pass through all the cycles of the “rounding process”.

The crystallization unit in accordance with this invention allows crystals to pass through any number of “rounding (dissolution) cycles” in accordance with the regime settings (cooling rate and circulation volume flow) on the order of hundreds to thousands.

Another advantage of the crystallization unit in accordance with the invention is that the unit consists of available, serially produced “conventional” devices and that the entire crystallizer is also of a simple design, i.e. the purchasing costs of the whole unit are not high.

The crystallization unit is discontinuous, of the charge type, which makes it suitable for small-scale production, too.

Another advantage provided by this invention is that the disturbed crystallization process by means of cooling is at the same time a purifying process for crystals unlike evaporation, which results in a high quality (purity) of crystals.

Thus, the crystallization unit in accordance with the invention produces required crystals of sufficient purity, proper size and shape.

### BRIEF DESCRIPTION OF DRAWINGS

FIG. 1—is a schematic drawing of the crystallization unit in accordance with the invention with one circulation circuit.

FIG. 2—is a schematic drawing of the crystallization unit in accordance with the invention with two circulation circuits.

FIG. 3—shows round ammonium perchlorate crystals produced by the crystallization unit in accordance with the invention

### EXAMPLES

### Example 1

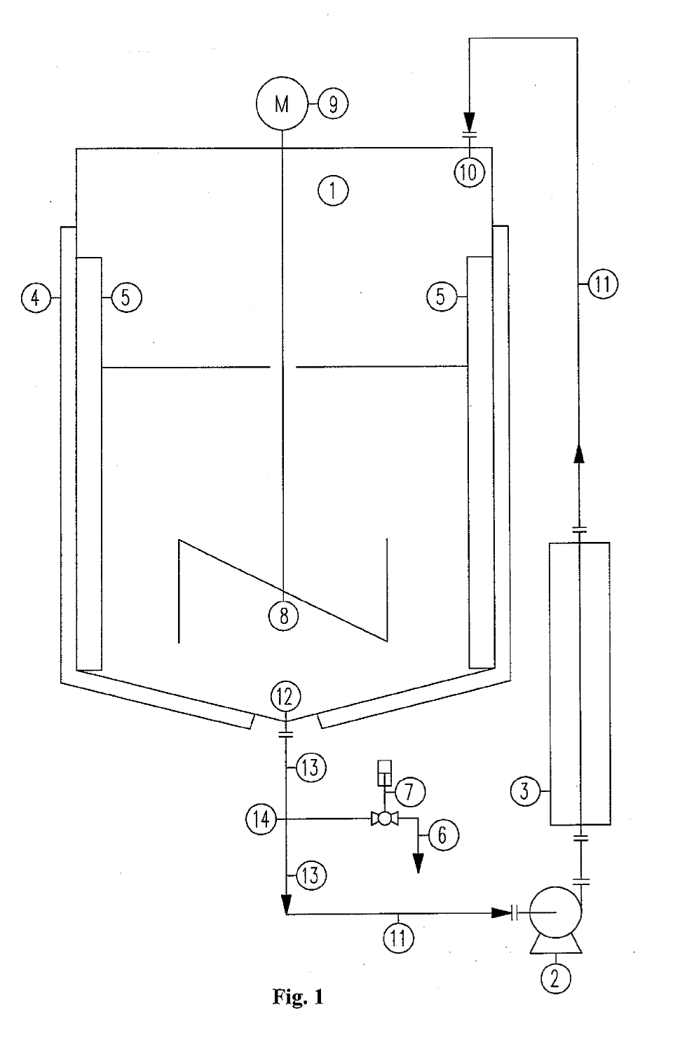

For the production of ball-shaped crystals of ammonium perchlorate a discontinuous crystallization unit has been used that comprised a crystallizer (1) that consisted of a metallic cylindrical vessel of an enameled metal with its inner surface of polished stainless steel, with an oval or circular cross-section with a conical or vaulted bottom (12), fitted along most of its length with a double jacket (4) for cooling of the solution and/or suspension of the solution and crystals and a high-speed agitator (8) of stainless steel with a drive (9) enabling speed control and thus the rate of the impact of the mechanical action of the agitator on roundness of crystals inside the vessel together with the inner surface of the vessel containing 2 baffles (5) of polished stainless steel while the vessel was fitted with 1 orifice (10) at the top that 1 independent circuit of the circulation pipeline (11) was connected to from the outside for the inlet of a heated solution and/or heated suspension of the solution and crystals by means of a circulation centrifugal pump (2) with an open impeller and through a tubular heat exchanger (3) and together with the double jacket (4) ensuring controlled periodic changes of temperatures of the crystal suspension around the cooling curve while an interconnection pipeline (13) was connected to the bottom (12) of the crystallizer (1) vessel that was connected to one circuit of the circulation pipeline (11) as shown in FIG. 1.

The raw material was rough-grained ammonium perchlorate (APC). It was produced during discontinuous crystallization in a plastic crystallizer fitted with cooling diffusers. APC crystals were separated from the mother liquor (ML) on a process filter and dried with process pressurized air. The moisture content of the crystals varied in the range of 5-10% by weight. Further, ML is used for the preparation of the APC solution, which is removed by filtration after the crystallization process described below.

700-1200 kg of rough-grained APC was dissolved in a process filter in 3500-4500 kg of ML, which was preferably heated up by steam using a tubular heat exchanger to a temperature of 50-90° C. This way an APC solution was produced that was saturated at temperatures in the range of 40-60° C. and then was re-pumped to a plastic tank.

Crystallization was conducted in the crystallizer described above as part of the crystallization unit in accordance with the invention one version of which is schematically illustrated in FIG. 1.

The APC solution from the plastic tank was pumped to the crystallizer in the quantity of 900-1200 kg. The solution was heated up as necessary in the tubular heat exchangers so that the resulting temperature in the crystallizer could vary in the range of 35-65° C. After filling of the crystallizer 1 the pump 2 was started that ensured the total flow of 30-100 m³/h of the APC solution and later the APC suspension through the exchanger 3 during the entire crystallization process.

Then, the agitator 8 was put in operation, the speed of its motor 9 being set with a frequency changer to the value of 60-240 rpm. The agitation also continued throughout the crystallization period.

Then, cooling of the APC solution followed, when in the first stage the solution was cooled to the initial crystallization temperature at the rate of 40-80° C./h. The initial crystallization temperature was in the range of 30-55° C. From this temperature the cooling rate was reduced to 2-15° C./h and at the same time heating of the solution, later suspension of APC in the exchanger 3 was started to ensure the 0.2-3.5° C. difference between the inlet and outlet APC solution temperature. Steam, water or other heat-carrying media can be used for the heating.

The crystallization process was completed when the temperature achieved 10-25° C. At this temperature heating of the solution by means of the exchanger 3 was turned off and the circulation pumps 2 and the agitator 8 were switched off.

The suspension was then pumped with a suitable pump via the interconnection pipeline 13, the T-piece 14 and automatic stop valves 7, which is a closing valve, and the branching pipe 6 for further processing in the process filter. There, ML is separated from APC crystals. Then, crystals are dried by the process pressure filter to the value of 90-98% by weight (related to the total weight with residual water).

APC crystals whose particle size distribution in accordance with sieve analysis is within the ranges presented in table 1 were prepared in the above mentioned method.

TABLE 1
Sieve analysis of obtained APC crystals

| Fraction | 0-100 μm | 100-150 μm | 150-180 μm | 180-300 μM | >300 μm |
|---|---|---|---|---|---|
| Weight | 3-10 | 4-19 | 12-35 | 40-75 | 0-6 |
| % | | | | | |

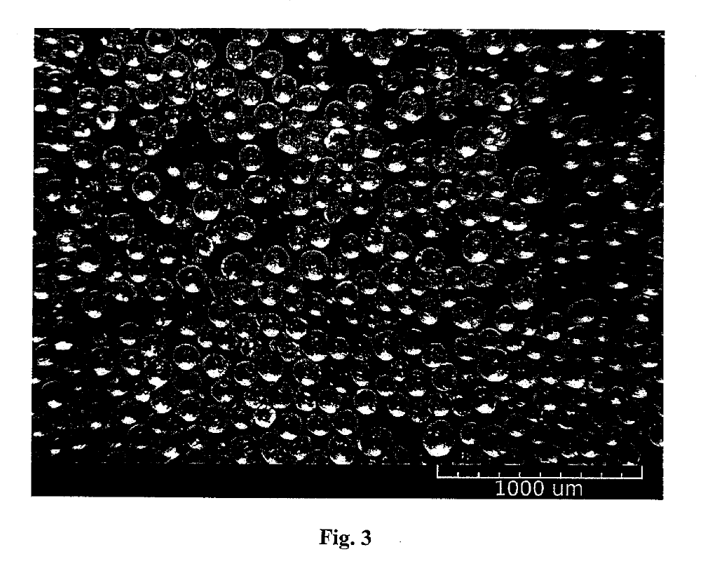

The size and shape of APC crystals are shown in FIG. 3.

### Example 2

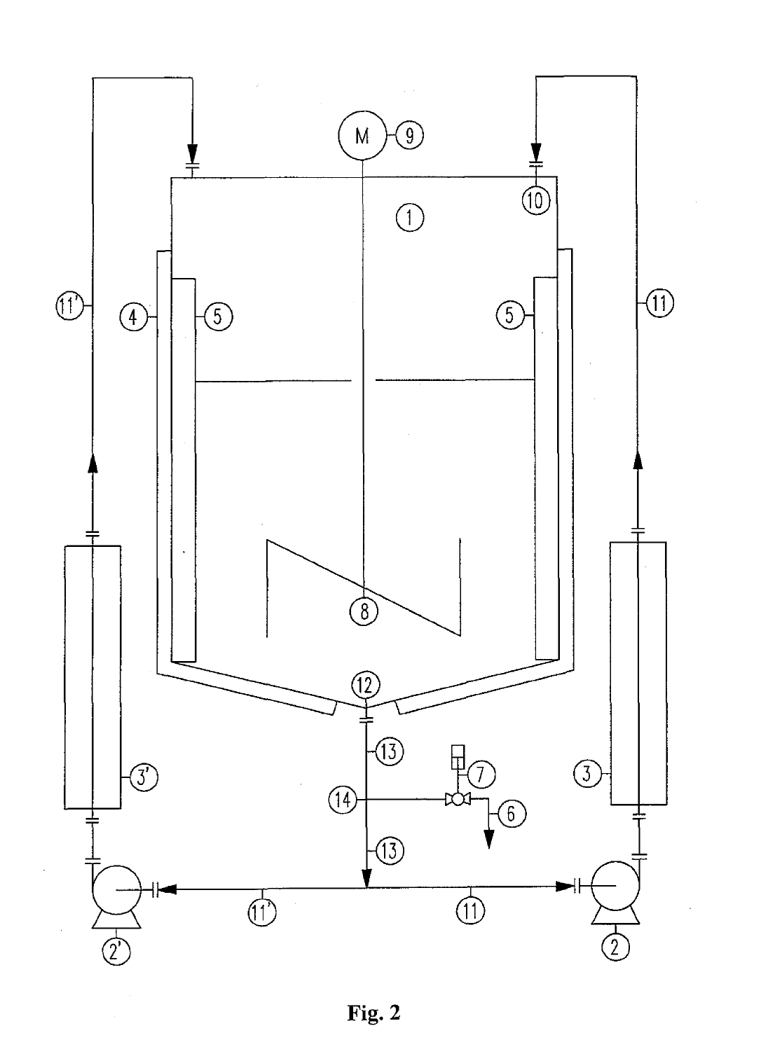

The same discontinuous crystallization unit was used as in Example 1, but it contained 2 circulation circuits 11, 11′ for the inlet of the heated solution or heated suspension of solution and crystals with the use of circulation pumps 2, 2′ and through heat exchangers 3 3′ as shown in FIG. 2.

This arrangement of the unit made it possible to increase the number of crystallization cycles at the same cooling rate and/or reduce the flow rate in the circulation circuit branch(es). The general APC crystal production process was the same as in Example 1.

The obtained crystals had a rounder shape; otherwise they exhibited the same purity and particle distribution as compared to Example 1.

1. A discontinuous crystallization unit for the production of ball-shaped crystals, characterized in that it comprises a crystallizer (1) that consists of a metallic cylindrical vessel with its inner surface of a hard material, with an oval or circular cross-section with a conical or vaulted bottom (12), fitted along its length with a duplicator (4) for cooling of the solution and/or suspension of the solution and crystals and a high-speed agitator (8) of a hard material with a drive (9) enabling speed control and thus the rate of the impact of the mechanical action of the agitator on roundness of crystals inside the vessel together with the inner surface of the vessel containing at least 2 baffles (5) of a hard material while the vessel is fitted with at least 1 orifice (10) at the top that at least 1 independent branch of the circulation circuit (11) is connected to from the outside for the inlet of a heated solution and/or heated suspension of the solution and crystals by means of at least 1 circulation pump (2) and through at least 1 heat exchanger (3) and together with the duplicator (4) ensuring controlled periodic changes of temperatures of the crystal suspension around the cooling curve while an interconnection (13) pipeline is connected to the bottom (12) of the crystallizer (1) vessel that is connected to at least one branch of the circulation circuit (11).

2. The discontinuous crystallization unit in accordance with claim 1, characterized in that the interconnection pipeline (13) before the connection to the circulation circuit branch (11) contains a branching element (14) with a branching pipe (6) with stop valve (7), preferably automatic for discharge crystals for further processing.

3. The discontinuous crystallization unit in accordance with claim 2, characterized in that the branching element (14) is a T-piece and that the stop valve (7) is a valve, cock, flap valve or slide valve.

4. The discontinuous crystallization unit in accordance with claim 1, characterized in that the hard material is stainless steel, enameled metal or glass.

5. The discontinuous crystallization unit in accordance with claim 1 or claim 4, characterized in that the hard material is a material with a hardness of at least 120 HB, preferably at least 200 HB.

6. The discontinuous crystallization unit in accordance with claim 1, characterized in that the exchanger(s) is(are) a tubular heat exchanger(s).

7. The discontinuous crystallization unit in accordance with claim 1, characterized in that the circulation pump(s) is(are) a centrifugal pump(s) with an open impeller of a hard material.

8. The discontinuous crystallization unit in accordance with claim 1, characterized in that the ball-shaped crystals are ammonium perchlorate crystals of a medium size from approx. 100 micrometers to approx. 300 micrometers, preferably approx. 200 micrometers.
